(19) United States
(12) Patent Application Publication
(10) Pub. No.: US 2024/0411422 A1
(43) Pub. Date: Dec. 12, 2024

(54) Object-Based Glint Grouping

(71) Applicant: Apple Inc., Cupertino, CA (US)

(72) Inventors: Paulo R. Jansen dos Reis, San Jose, CA (US); Christopher D. Fu, Fremont, CA (US)

(21) Appl. No.: 18/695,280

(22) PCT Filed: Aug. 30, 2022
(86) PCT No.: PCT/US2022/042037

§ 371 Date: Mar. 25, 2024

Related U.S. Application Data
(60) Provisional application No. 63/247,982, filed on Sep. 24, 2021.

(51) Int. Cl. G06F 3/04817; G06V 10/26; G06V 10/762

(52) U.S. Cl. CPC G06F 3/04817; G06V 10/26; G06V 10/762

(57) ABSTRACT

In one implementation, a method of displaying a plurality of glints method includes capturing an image of an environment including a plurality of objects. The method includes detecting, in the image of the environment, a plurality of actionable items respectively associated with a plurality of actions. The method includes relating the actionable items to respective ones of the plurality of objects. The method includes displaying a plurality of group user interface elements in respective association with the plurality of objects. The method includes detecting user input directed to a particular group user interface element of the plurality of group user interface elements associated with a particular object of the plurality of objects. The method includes displaying a plurality of user interface elements in respective association with those of the plurality of actionable items related to the particular object.

### CROSS-REFERENCE TO RELATED APPLICATIONS

This application claims priority to U.S. Provisional Patent App. No. 63/247,982, filed on Sep. 24, 2021, which is hereby incorporated by reference in its entirety.

### TECHNICAL FIELD

The present disclosure generally relates to systems, methods, and devices for displaying group glints, each representing a plurality of glints, in association with corresponding objects.

### BACKGROUND

An electronic device equipped with a camera can detect actionable items, e.g., objects and/or information associated with respective actions, in an image of an environment and present glints indicating the detection which, when selected, performs the respective action. However, in various implementations, the field-of-view may become overcrowded with glints diminishing the user experience.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 is a block diagram of an example controller in accordance with some implementations.

FIG. 3 is a block diagram of an example electronic device in accordance with some implementations.

FIGS. 4A-4L illustrate an XR environment during various time periods in accordance with some implementations.

FIG. 5 is a flowchart representation of a method of displaying a plurality of glints in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying a plurality of user interface elements. In various implementations, the method is performed by a device including an image sensor, a display, one or more processors, and non-transitory memory. The method includes capturing, using the image sensor, an image of an environment including a plurality of objects. The method includes detecting, in the image of the environment, a plurality of actionable items respectively associated with a plurality of actions. The method includes relating each of the plurality of actionable items to a respective one of the plurality of objects. The method includes displaying a plurality of group user interface elements in respective association with the plurality of objects, each group user interface element representing a plurality of user interface elements. The method includes detecting user input directed to a particular group user interface element of the plurality of group user interface elements associated with a particular object of the plurality of objects. The method includes displaying, on the display, a plurality of user interface elements in respective association with those of the plurality of actionable items related to the particular object.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

As noted above, an electronic device equipped with a camera can detect actionable items, e.g., objects and/or information associated with respective actions, in an image of an environment and present glints in association with the actionable items. A glint is a user interface element. In various implementations, performing the respective action includes displaying the glint. For example, in various implementations, the respective action includes displaying information associated with the actionable item and the glint includes the information. In various implementations, a glint is an affordance which, when selected, performs the respective action of the actionable item or, at least, displays an action affordance for performing the respective action. In various implementations, a glint is a world-locked virtual object presented in association with its respective actionable item. For example, in various implementations, a glint is a small glowing circle presented at a location in the environment proximate to the location of a detected actionable items.

In various implementations, the field-of-view may become overcrowded with glints diminishing the user experience. Accordingly, in various implementations, glints are grouped into groups represented by group glints which when selected, present the constituent glints. In various implementations, the glints are grouped by proximity. In various implementations, the glints are grouped by object.

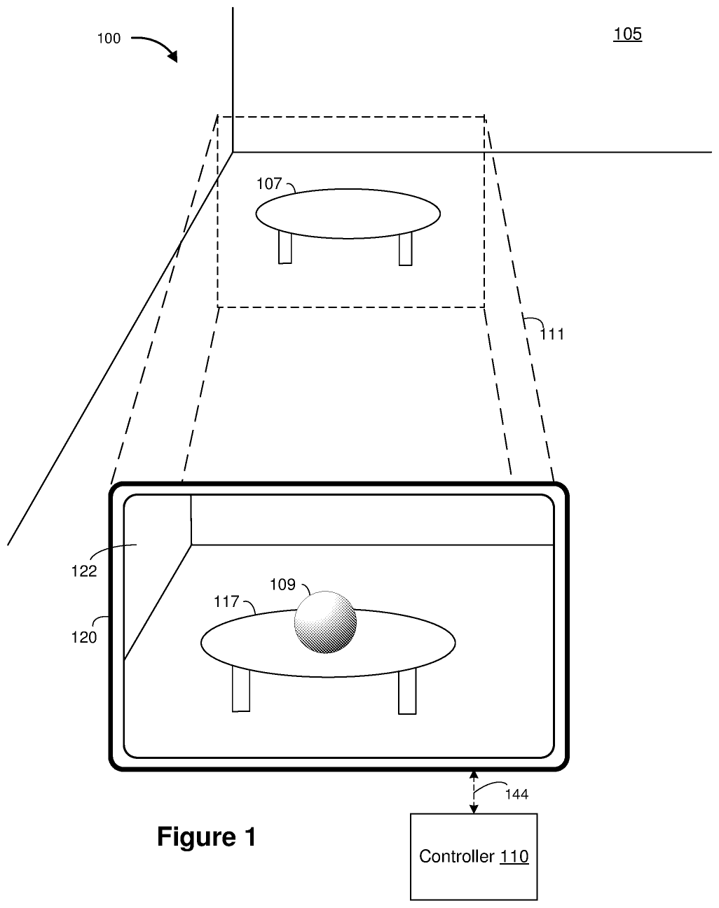

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

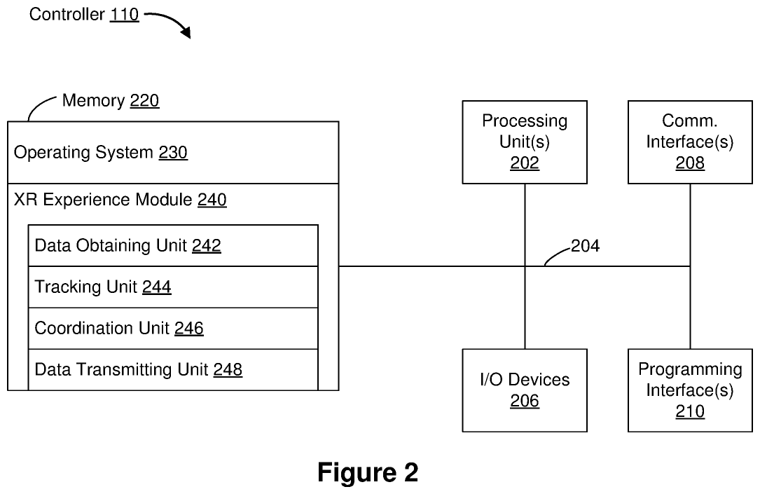

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

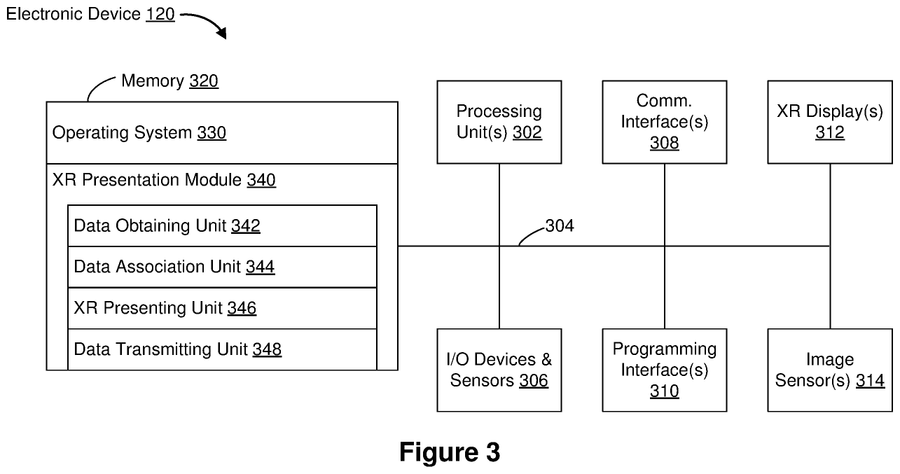

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR sphere 109) and to enable video pass-through of the physical environment 105 (e.g., including a representation 117 of the table 107) on a display 122. The electronic device 120 is described in greater detail below with respect to FIG. 3.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and an XR experience module 240.

The operating system 230 includes procedures for handling various basic system services and for performing hardware dependent tasks. In some implementations, the XR experience module 240 is configured to manage and coordinate one or more XR experiences for one or more users (e.g., a single XR experience for one or more users, or multiple XR experiences for respective groups of one or more users). To that end, in various implementations, the XR experience module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the electronic device 120 of FIG. 1. To that end, in various implementations, the data obtaining unit 242 includes instructions and/or logic therefor, and heuristics and metadata therefor.

In some implementations, the tracking unit 244 is configured to map the physical environment 105 and to track the position/location of at least the electronic device 120 with respect to the physical environment 105 of FIG. 1. To that end, in various implementations, the tracking unit 244 includes instructions and/or logic therefor, and heuristics and metadata therefor.

In some implementations, the coordination unit 246 is configured to manage and coordinate the XR experience presented to the user by the electronic device 120. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the electronic device 120. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 312 are configured to provide the XR experience to the user. In some implementations, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 312 correspond to diffractive, reflective, polarized, holographic, etc. waveguide displays. For example, the electronic device 120 includes a single XR display. In another example, the electronic device includes an XR display for each eye of the user. In some implementations, the one or more XR displays 312 are capable of presenting MR and VR content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the scene as would be viewed by the user if the electronic device 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an XR presentation module 340.

The operating system 330 includes procedures for handling various basic system services and for performing hardware dependent tasks. In some implementations, the XR presentation module 340 is configured to present XR content to the user via the one or more XR displays 312. To that end, in various implementations, the XR presentation module 340 includes a data obtaining unit 342, a glint grouping unit 344, an XR presenting unit 346, and a data transmitting unit 348.

In some implementations, the data obtaining unit 342 is configured to obtain data (e.g., presentation data, interaction data, sensor data, location data, etc.) from at least the controller 110 of FIG. 1. In various implementations, the data obtaining unit 342 is configured to obtain data regarding actionable items detected in an image of an environment. To that end, in various implementations, the data obtaining unit 342 includes instructions and/or logic therefor, and heuristics and metadata therefor.

In some implementations, the glint grouping unit 344 is configured to group the actionable items into a plurality of groups based on objects associated with the actionable items. To that end, in various implementations, the glint grouping unit 344 includes instructions and/or logic therefor, and heuristics and metadata therefor.

In some implementations, the XR presenting unit 346 is configured to present XR content via the one or more XR displays 312, such as a plurality of group glints corresponding to the plurality of groups. To that end, in various implementations, the XR presenting unit 346 includes instructions and/or logic therefor, and heuristics and metadata therefor.

In some implementations, the data transmitting unit 348 is configured to transmit data (e.g., presentation data, location data, etc.) to at least the controller 110. To that end, in various implementations, the data transmitting unit 348 includes instructions and/or logic therefor, and heuristics and metadata therefor.

Although the data obtaining unit 342, the glint grouping unit 344, the XR presenting unit 346, and the data transmitting unit 348 are shown as residing on a single device (e.g., the electronic device 120), it should be understood that in other implementations, any combination of the data obtaining unit 342, the glint grouping unit 344, the XR presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

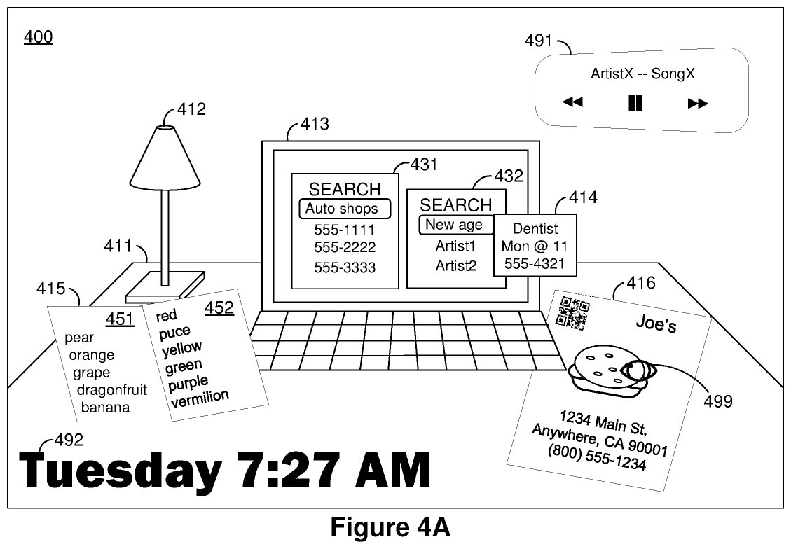

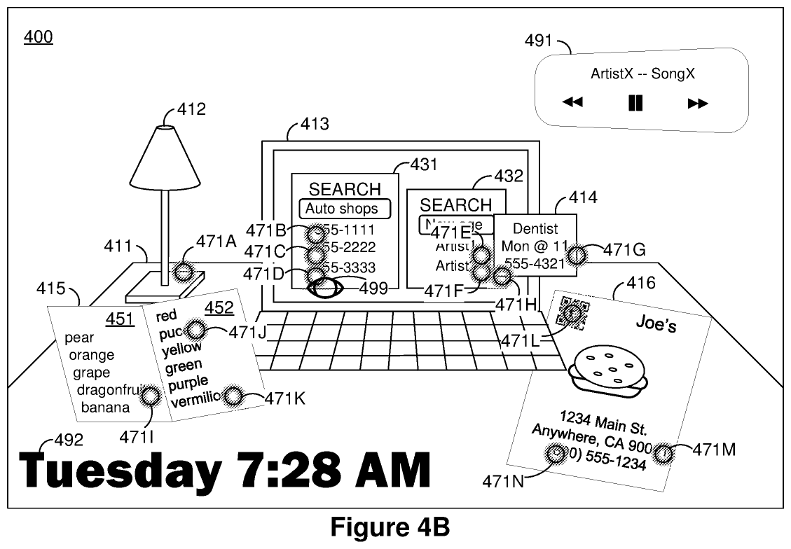

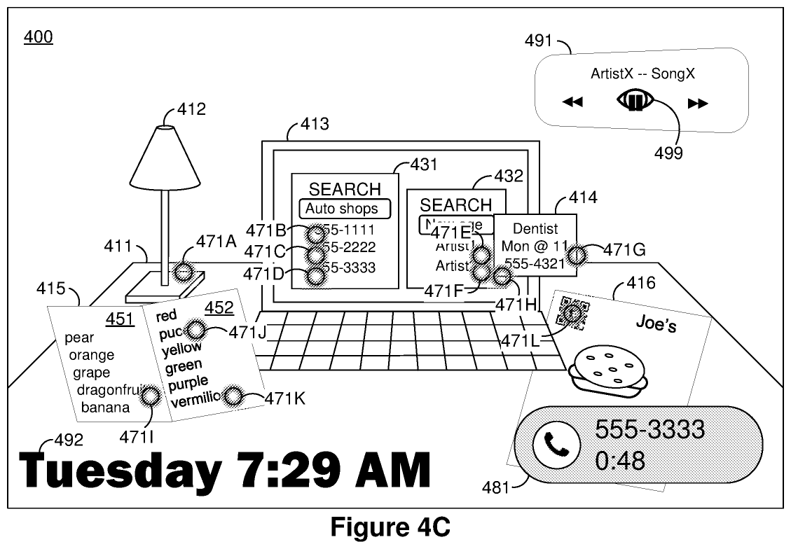

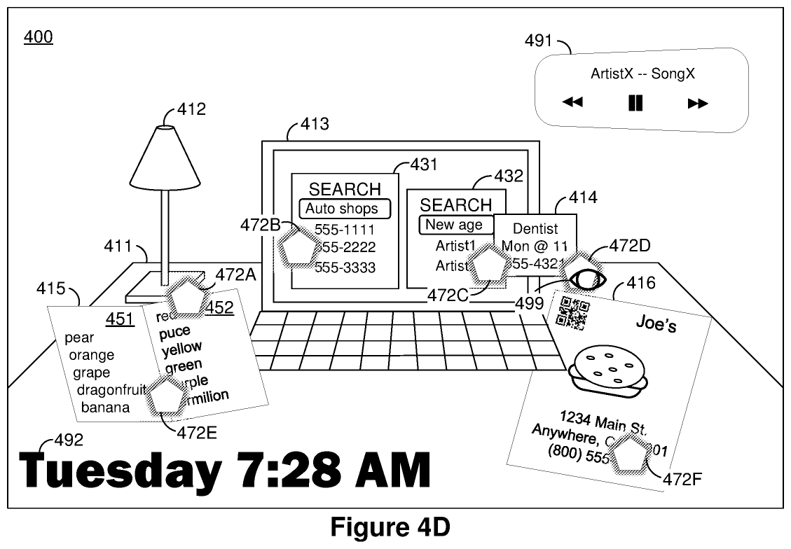

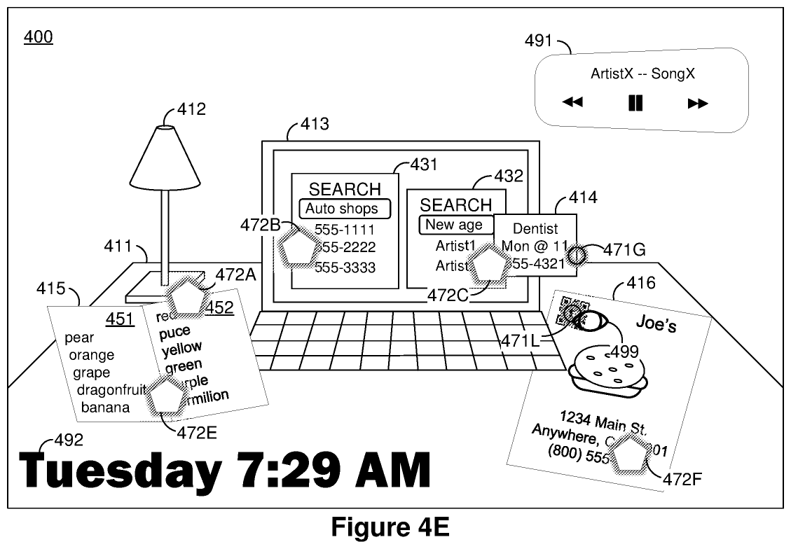

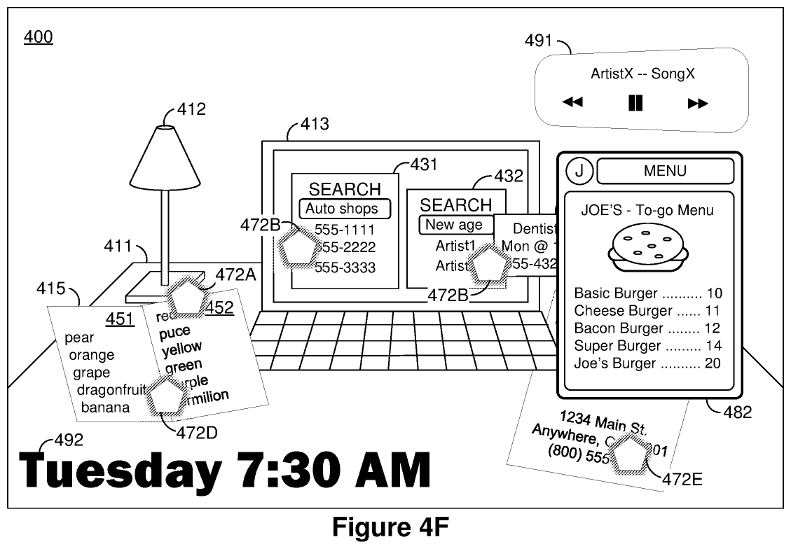

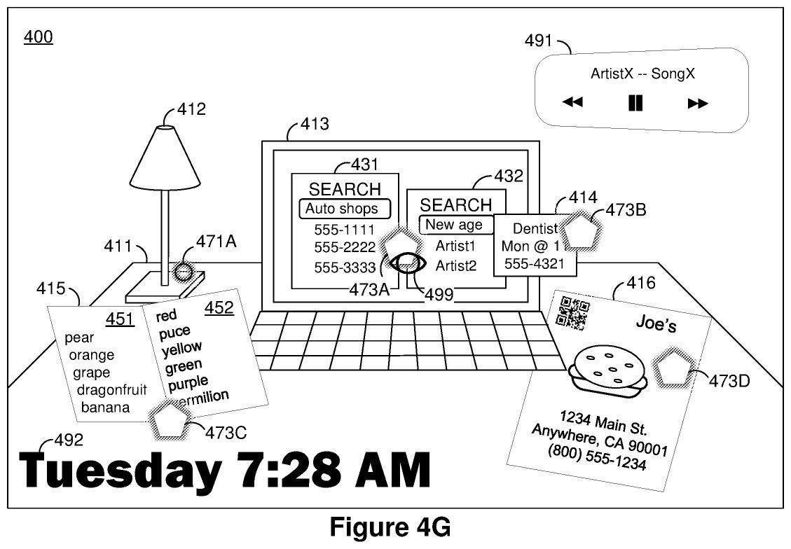

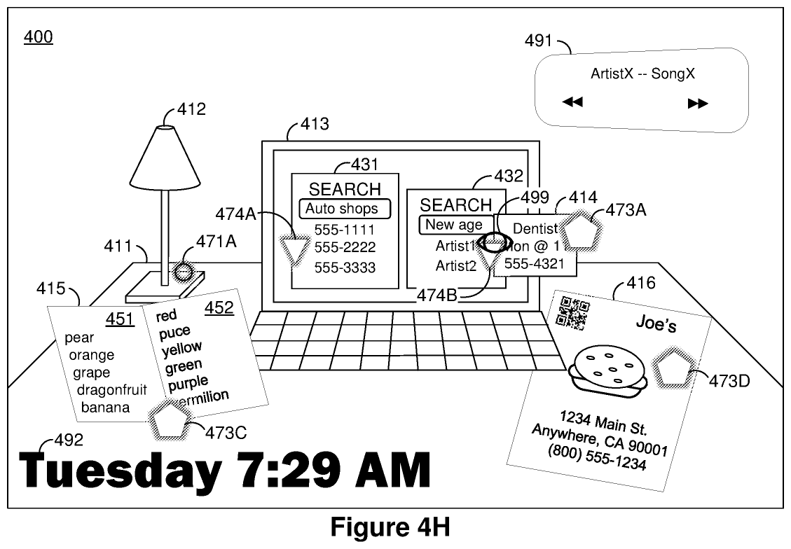

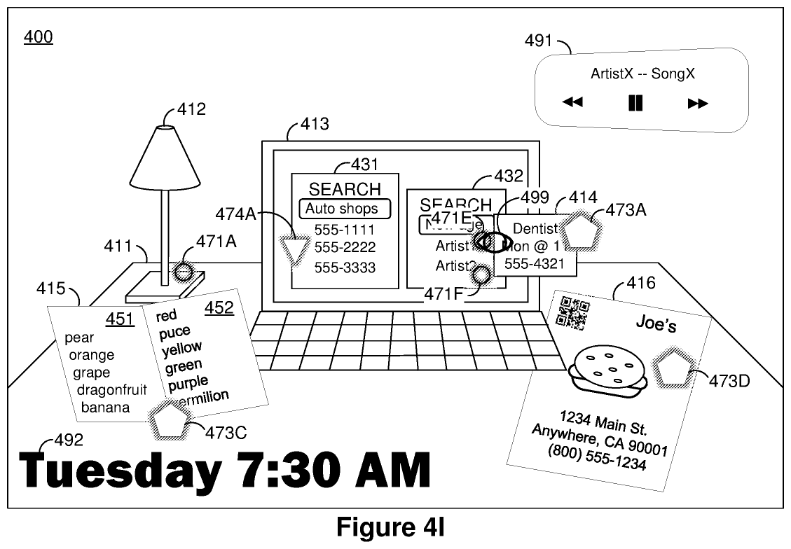

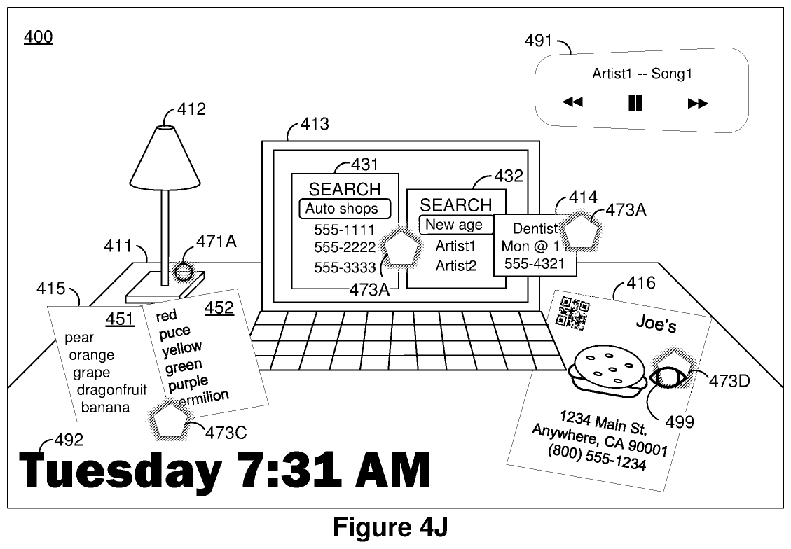

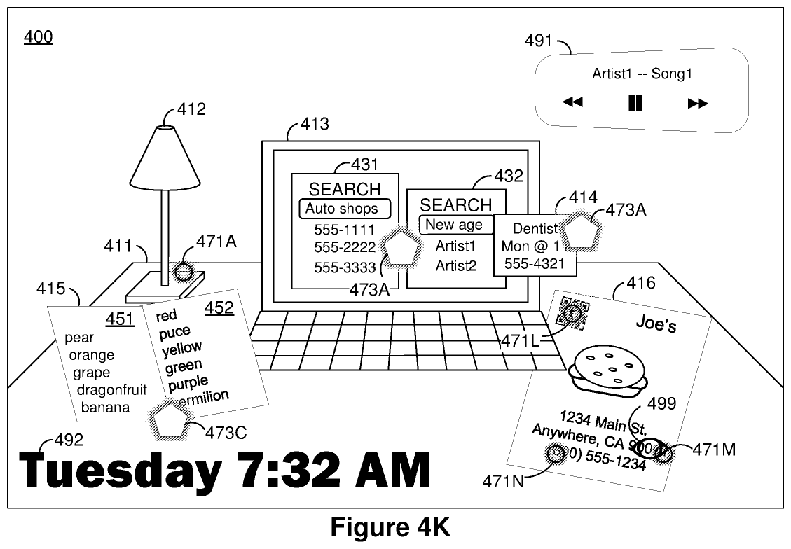

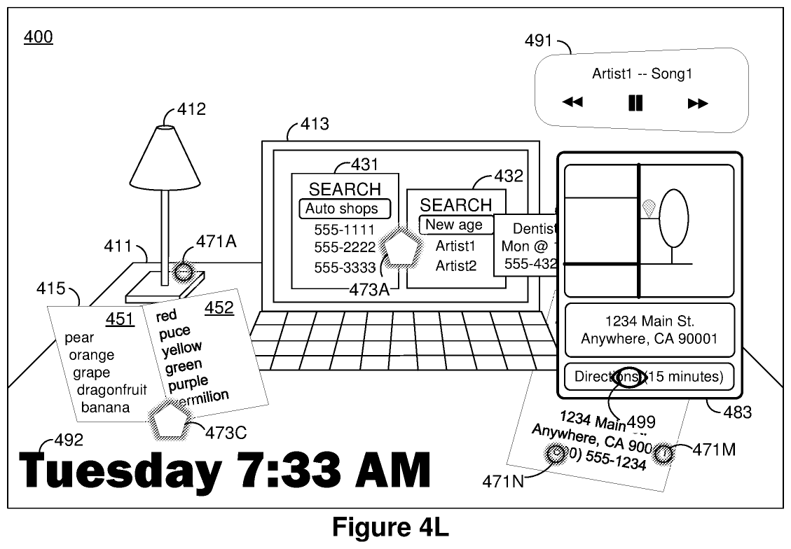

FIGS. 4A-4L illustrate an XR environment 400 presented, at least in part, by a display of an electronic device, such as the electronic device 120 of FIG. 3. The XR environment 400 is based on a physical environment in which the electronic device is present. FIGS. 4A-4L illustrate the XR environment 400 during a series of time periods in various implementations. In various implementations, each time period is an instant, a fraction of a second, a few seconds, a few hours, a few days, or any length of time.

FIGS. 4A-4L illustrate a gaze location indicator 499 that indicates a gaze location of the user, e.g., where in the XR environment 400 the user is looking. Although the gaze location indicator 499 is illustrated in FIGS. 4A-4L, in various implementations, the gaze location indicator is not displayed by the electronic device.

FIG. 4A illustrates the XR environment 400 during a first time period. The XR environment 400 is based on a physical environment of an office in which the electronic device is present.

The XR environment 400 includes a plurality of objects, including one or more physical objects (e.g., a desk 411, a lamp 412, a laptop 413, a sticky note 414, a book 415, and a takeout menu 416) of the physical environment and one or more virtual objects (e.g., a virtual media player window 491 and a virtual clock 492). In various implementations, certain objects (such as the physical objects and the virtual media player window 491) are presented at a location in the XR environment 400, e.g., at a location defined by three coordinates in a common three-dimensional (3D) XR coordinate system such that while some objects may exist in the physical world and others may not, a spatial relationship (e.g., distance or orientation) may be defined between them. Accordingly, when the electronic device moves in the XR environment 400 (e.g., changes either position and/or orientation), the objects are moved on the display of the electronic device, but retain their location in the XR environment 400. Such virtual objects that, in response to motion of the electronic device, move on the display, but retain their position in the XR environment 400 are referred to as world-locked objects. In various implementations, certain virtual objects (such as the virtual clock 492) are displayed at locations on the display such that when the electronic device moves in the XR environment 400, the objects are stationary on the display on the electronic device. Such virtual objects that, in response to motion of the electronic device, retain their location on the display are referred to display-locked objects.

In the XR environment 400, the lamp 412, the laptop 413, the book 415, and the takeout menu 416 sit atop the desk 411. Further, the sticky note 414 is attached to the laptop 413. The laptop 413 displays a first window 431 including search results for local automobile repair shops, including a phone number of a first auto shop, a phone number of a second auto shop, and a phone number of a third auto shop. The laptop 413 further displays a second window 432 including search results for artists of New Age music, including a name of a first artist and a name of a second artist.

The sticky note 414 has written thereon a reminder of a dentist's appointment including a time-and-date and a phone number of a dentist. The book 415 includes a first page 451 including a list of fruits and second page including a list of colors. The takeout menu 416 includes an address of a restaurant, a phone number of the restaurant, and a QR code encoding the URL of a webpage of the restaurant.

The virtual media player window 491 indicates that the electronic device is playing a song entitled “SongX” by an artist named “ArtistX”. The virtual clock 492 indicates a current day and time.

During the first time period, as indicated by the gaze location indicator 499 the user is looking at the takeout menu 416.

During the first time period, the electronic device scans the XR environment 400 to detect actionable items, e.g., objects and/or information associated with respective actions using, e.g., computer-vision techniques such as model trained to detect and classify various objects or detect and interpret machine-readable content. For example, using object recognition, the electronic device detects the lamp 412 which is associated with an action of turning the lamp on or off. As another example, using text recognition, in the first window 431 displayed by the laptop 413, the electronic device detects the phone number of the first auto shop which is associated with an action of calling the phone number of the first auto shop.

FIG. 4B illustrates the XR environment 400 in an ungrouped implementation during a second time period subsequent to the first time period. In FIG. 4B, in response to detecting a plurality of actionable items associated with plurality of respective actions, the XR environment 400 includes a respective plurality of glints 471A-471N. Each of the plurality of glints 471A-471N indicates the detection of an actionable item in the XR environment 400.

A glint is a user interface element. In various implementations, performing the respective action includes displaying the glint. For example, in various implementations, the respective action includes displaying information associated with the actionable item and the glint includes the information. In various implementations, a glint is an affordance which, when selected, performs the respective action of the actionable item or, at least, displays an action affordance for performing the respective action. In various implementations, a glint is a world-locked virtual object presented in association with its respective actionable item. For example, in various implementations, a glint is a small glowing circle presented at a location in the environment proximate to the location of a detected actionable items.

In FIG. 4B, in response to detecting the lamp 412 which is associated with an action of turning the lamp on or off, the XR environment 400 includes a first glint 471A. In response to detecting, in the first window 431 displayed by the laptop 413, the phone number of the first auto shop associated with an action of calling the phone number of the first auto shop, the XR environment 400 includes a second glint 471B. In response to detecting, in the first window 431 displayed by the laptop 413, the phone number of the second auto shop associated with an action of calling the phone number of the second auto shop, the XR environment 400 includes a third glint 471C. In response to detecting, in the first window 431 displayed by the laptop 413, the phone number of the third auto shop associated with an action of calling the phone number of the third auto shop, the XR environment 400 includes a fourth glint 471D.

In response to detecting, in the second window 432 displayed by the laptop 413, the name of the first artist associated with an action of playing music by the first artist, the XR environment 400 includes a fifth glint 471E. In response to detecting, in the second window 432 displayed by the laptop 413, the name of the second artist associated with an action of playing music by the second artist, the XR environment 400 includes a sixth glint 471F.

In response to detecting, on the sticky note 414, the time-and-date associated with an action of generating a calendar event for that time-and-date in a calendar application, the XR environment 400 includes a seventh glint 471G. In response to detecting, on the sticky note 414, the phone number of the dentist associated with an action of calling the phone number of the dentist, the XR environment 400 includes an eighth glint 471H.

In response to detecting, on the first page 451 of the book 415, the uncommon word “dragonfruit” associated with an action of displaying a dictionary definition or encyclopedia entry of the word, the XR environment 400 includes a ninth glint 471I. In response to detecting, on the second page 451 of the book 415, the uncommon word “puce” associated with an action of displaying a dictionary definition or encyclopedia entry of the word, the XR environment 400 includes a tenth glint 471J. In response to detecting, on the second page 452 of the book 415, the uncommon word “vermilion” associated with an action of displaying a dictionary definition or encyclopedia entry of the word, the XR environment 400 includes an eleventh glint 471K.

In response to detecting, on the takeout menu 416, the QR code associated with an action of opening the webpage having the URL encoded by the QR code, the XR environment 400 includes a twelfth glint 471L. In response to detecting, on the takeout menu 416, the address of the restaurant associated with an action of displaying a map of the address and/or directions to the address in a map application, the XR environment 400 includes a thirteenth glint 471M. In response to detecting, on the takeout menu 416, the phone number of the restaurant associated with an action of calling the phone number of the restaurant, the XR environment 400 includes a fourteenth glint 471N.

In various implementations, the respective action includes displaying information associated with the respective actionable item. For example, in various implementations, the action associated with the uncommon word “dragonfruit” is displaying a dictionary definition of the word. In various implementations, the associated glint (e.g., the ninth glint 471I) is not an affordance for displaying the dictionary definition, but is a user interface element that includes the dictionary definition. Thus, in various implementations, performing the action associated with the actionable item includes displaying the glint. In various implementations, the glint including the dictionary definition is not an affordance for performing a further action. In various implementations, the glint including the dictionary definition is affordance for displaying an encyclopedia entry of the word.

In various implementations, different glints are generated by different applications executed by the electronic device. For example, in various implementations, the first glint 471A associated with the lamp is generated by a smart home application. As another example, in various implementations, the ninth glint 471I, tenth glint 471J, and eleventh glint 471K associated with the book 415 are generated by a dictionary application. As another example, the fifth glint 471E and sixth glint 471F are generated by a music application.

In various implementations, different glints associated with different types of actions (e.g., generated by different applications) are displayed differently. In various implementations, the different glints are displayed with a different size, shape, or color. For example, in various implementations, the first glint 471A associated the action of controlling a smart home device is displayed with a first color and the second glint 471B, third glint 471C, fourth glint 471D, eighth glint 471F, and fourteenth glint 471N each associated with calling a phone number are displayed with a second color.

In various implementations, different glints associated with different types of actions are displayed in association with their respective actionable items in different ways. For example, in various implementations, the ninth glint 471I, tenth glint 471J, and eleventh glint 471K each associated with the action of displaying a dictionary definition or encyclopedia entry of an uncommon word are displayed at the end of their respective words, allowing a user to read the entire word before deciding whether to select the glint to receive additional information. As another example in contrast, in various implementations, the second glint 471B, third glint 471C, fourth glint 471D, eighth glint 471F, and fourteenth glint 471N each associated with calling a phone number are displayed at the beginning of the respective phone number to obscure less informative information, such as an area code which may be common to many phone numbers in the field-of-view. As another example, in various implementations, the twelfth glint 471L associated with the action of opening a webpage having a URL encoded by a QR code is displayed centrally over the QR code so as to obscure human-unreadable information while minimizing obscuration of any other part of the field-of-view.

As noted above, each of the plurality of glints 471A-471N is a user interface element which, when selected, performs the respective action of the actionable item or, at least, provides the user the option to perform the respective action. In various implementations, a user selects the glint by performing a hand gesture (e.g., a pinch-and-release gesture) at the location of the glint. In various implementations, the user selects the glint by looking at the glint and performing a head gesture, such as a nod, a wink, a blink, or an eye swipe (in which the gaze of the user swipes across the glint. In various implementations, the user selects the glint by looking at the glint and performing a hand gesture. In various implementations, the user selects the glint by looking at the glint and performing a vocal gesture (e.g., saying “open”). In various implementation, while a user is looking at a glint, the glint is displayed differently, e.g., bigger or brighter, to indicate that the user is looking at the glint.

During the second time period in the ungrouped implementation, the user selects the fourth glint 471D. Accordingly, the gaze location indicator 499 indicates that the user is looking at the fourth glint 471D.

FIG. 4C illustrates the XR environment 400 in the ungrouped implementation during a third time period subsequent to the second time period. In response to detecting selection of the fourth glint 471D, the electronic device performs the action associated with the fourth glint 471D, e.g., calling the phone number of the third auto shop. Accordingly, in FIG. 4C, the XR environment 400 includes an active call indicator 481 indicating that the user is engaged in a telephone call with the phone number of the third auto shop and has been for 48 seconds. In various implementations, the active call indicator 481 is a display-locked virtual object.

As illustrated in FIG. 4B and FIG. 4C, in an ungrouped implementation, a large number of glints can clutter the field-of-view of the XR environment 400. Further, when a user selects a glint to perform an action, such cluttering and inaccuracy in determining the gaze location of the user may make it difficult to accurately determine which glint a user has selected. Accordingly, in various implementations, glints are grouped into groups and represented by group glints which when selected, expand to display the glints of the group.

In various implementations, glints are grouped based on proximity to other glints. Various clustering algorithms may be used for grouping glints based on proximity. For example, in various implementations, for a number of locations in a three-dimensional coordinate system of the XR environment 400, each glint within a threshold distance of the location is grouped into a corresponding group and represented by a group glint at the location. As another example, in various implementations, for a number of locations in a two-dimensional coordinate system of the display, each glint within a threshold distance of the location is grouped into a corresponding group and represented by a group glint at the location.

FIG. 4D illustrates the XR environment 400 in a proximity-based grouped implementation during the second time period. In FIG. 4D, the first glint 471A associated with the lamp 412 and the tenth glint 471J associated with the word “puce” are grouped into a first group and represented by a first group glint 472A. The second glint 471B, third glint 471C, and fourth glint 471D associated with the first window 431 of the laptop 413 are grouped into a second group and represented by a second group glint 472B. The fifth glint 471E and sixth glint 471F associated with the second window 432 of the laptop 413 are grouped with the eighth glint 471H associated with the phone number of the dentist on the sticky note 414 into a third group represented by a third group glint 472C.

The seventh glint 471G associated with the time-and-date on the sticky note 414 and the twelfth glint 471L associated with QR code on the takeout menu 416 are grouped into a fourth group represented by a fourth group glint 472D. The ninth glint 471I associated with the word “dragonfruit” and the eleventh glint 471K associated with the word “vermilion” are grouped into a fifth group represented a fifth group glint 472E. The thirteenth glint 471M associated with the address of the restaurant on the takeout menu 416 and the fourteenth glint 471N associated with the phone number of the restaurant on the takeout menu 416 are grouped into a sixth group represented by the sixth group glint 472F.

In various implementations, group glints are displayed differently than glints, which may be referred to as “action glints”. For example, in various implementations, the group glints are bigger or brighter. In various implementations, the group glints are a different size, shape, or color than the glints.

During the second time period in the proximity-based grouped implementation, the user selects the fourth group glint 472D. Accordingly, the gaze location indicator 499 indicates that user is looking at the fourth group glint 472D.

FIG. 4E illustrates the XR environment 400 in the proximity-based grouped implementations during the third time period. In response to selection of the fourth group glint 472D, the fourth group glint 472D is replaced by its constituent glints, e.g., the seventh glint 471G and the twelfth glint 471L. During the third time period in the proximity-based grouped implementation, the user selects the twelfth glint 471L. Accordingly, the gaze location indicator 499 indicates that user is looking at the twelfth glint 471L.

FIG. 4F illustrates the XR environment in the proximity-based grouped implementation during a fourth time period subsequent to the third time period. In response to detecting selection of the twelfth glint 471L, the electronic device performs the action associated with the twelfth glint 471L, e.g., opening up the webpage having the URL encoded by the QR code on the takeout menu 416. Accordingly, in FIG. 4F, the XR environment 400 includes a virtual web browser window 482 displaying the webpage having the URL encoded by the QR code. In various implementations, the virtual web browser window 482 is a world-locked virtual object.

Proximity-based grouping has a number of disadvantages. In various implementations, glints whose only relation is proximity may be unnaturally grouped together. For example, in FIG. 4D, the first glint 471A associated with the lamp 412 and the tenth glint 471J associated with the word “puce” are grouped together into the first group represented by the first group glint 472A. Further, glints may be difficult to find. A user wishing to select the glint associated with the time-and-date on the sticky note 414 may presume the glint is grouped with the fourth group represented by the fourth group glint 472D rather than the third group represented by the third group glint 472C. Further, movement of the objects in the XR environment 400 or movement of the user causing a change in perspective may require regrouping of glints as the distance (in the three-dimensional coordinate system of the XR environment 400 or the two-dimensional coordinate system of the display) between glints changes.

Accordingly, in various implementations, glints are grouped based on their associated objects. For each object detected in the environment associated with multiple glints, the multiple glints are grouped into a group and represented by a group glint displayed in association with the object.

FIG. 4G illustrates the XR environment 400 in an object-based grouped implementation during the second time period. In FIG. 4D, the first glint 471A associated with the lamp 412 is ungrouped and displayed in association with the lamp 412. The second glint 471B, third glint 471C, fourth glint 471D, fifth glint 471E, and sixth glint 471F, each associated with information displayed by the laptop 413 are grouped into a first group and represented by a first group glint 473A displayed in association with the laptop 413. The seventh glint 471G and eighth glint 471H each associated with information on the sticky note 414 are grouped into a second group and represented by a second group glint 473B displayed in association with the sticky note 414. The ninth glint 471I, tenth glint 471J, and eleventh glint 471K each associated with a word printed in the book 415 are grouped into a third group and represented by a third group glint 473C displayed in association with the book 415. The twelfth glint 471L, thirteenth glint 471M, and fourteenth glint 471N each associated with information on the takeout menu 416 are grouped into a fourth group and represented by a fourth group glint 473D displayed in association with the takeout menu 416.

During the second time period in the object-based grouped implementation, the user selects the first group glint 473A. Accordingly, the gaze location indicator 499 indicates that user is looking at the first group glint 473A. In various implementations, when an object is associated with a large number of glints, the glints are grouped into sub-groups and the sub-groups are grouped into a group associated with the object. In various implementations, the sub-groups correspond to detectable components of the object, such as the different windows 431, 432 displayed by the laptop 413 or the different pages 451, 452 of the book 415.

FIG. 4H illustrates the XR environment 400 in the object-based grouped implementation during the third time period. In response to selection of the first group glint 473A, the first group glint 473A is replaced by (1) a first sub-group glint 474A associated with the first window 431 displayed by the laptop 413, representing the second glint 471B, third glint 471C, and fourth glint 471D, and displayed in association with the first window 431 and (2) a second sub-group glint 474B associated with the second window 432 displayed by the laptop 413, representing the fifth glint 471E and sixth glint 471F, and displayed in association with the second window 432. During the third time period in the object-based grouped implementation, the user selects the second sub-group glint 474B. Accordingly, the gaze location indicator 499 indicates that user is looking at the second sub-group glint 474B.

FIG. 4I illustrates the XR environment 400 in the object-based grouped implementations during the fourth time period. In response to selection of the second sub-group glint 474B, the second sub-group glint 474B is replaced by its constituent glints, e.g., the fifth glint 471E and the sixth glint 471F. During the fourth time period in the object-based grouped implementation, the user selects the fifth glint 471E. Accordingly, the gaze location indicator 499 indicates that user is looking at the fifth glint 471E.

FIG. 4J illustrates the XR environment in the object-based grouped implementation during a fifth time period subsequent to the fourth time period. In response to detecting selection of the fifth glint 471E, the electronic device performs the action associated with the fifth glint 471E, e.g., playing music by the artist named “Artist1”. Accordingly, in FIG. 4J, the virtual media player window 491 indicates that the electronic device is playing a song entitled “Song1” by the artist named “Artist1.”

During the fifth time period in the object-based grouped implementation, the user selects the fourth group glint 473D. Accordingly, the gaze location indicator 499 indicates that user is looking at the fourth group glint 473D.

FIG. 4K illustrates the XR environment 400 in the object-based grouped implementation during a sixth time period subsequent to the fifth time period. In response to selection of the fourth group glint 473D, the fourth group glint 473D is replaced by its constituent glints, e.g., the twelfth glint 471L, the thirteenth glint 471M, and the fourteenth glint 471N. During the sixth time period in the proximity-based grouped implementation, the user selects the thirteenth glint 471M. Accordingly, the gaze location indicator 499 indicates that user is looking at the thirteenth glint 471M.

FIG. 4L illustrates the XR environment 400 in the object-based grouped implementation during a seventh time period subsequent to the sixth time period. In response to selection of the thirteenth glint 471M, the electronic device performs the action associated with the thirteenth glint 471M, e.g., displaying a map of the address of the restaurant. Accordingly, in FIG. 4L, the XR environment includes a virtual map application window 483. In various implementations, the virtual map application window 483 is a world-locked virtual object.

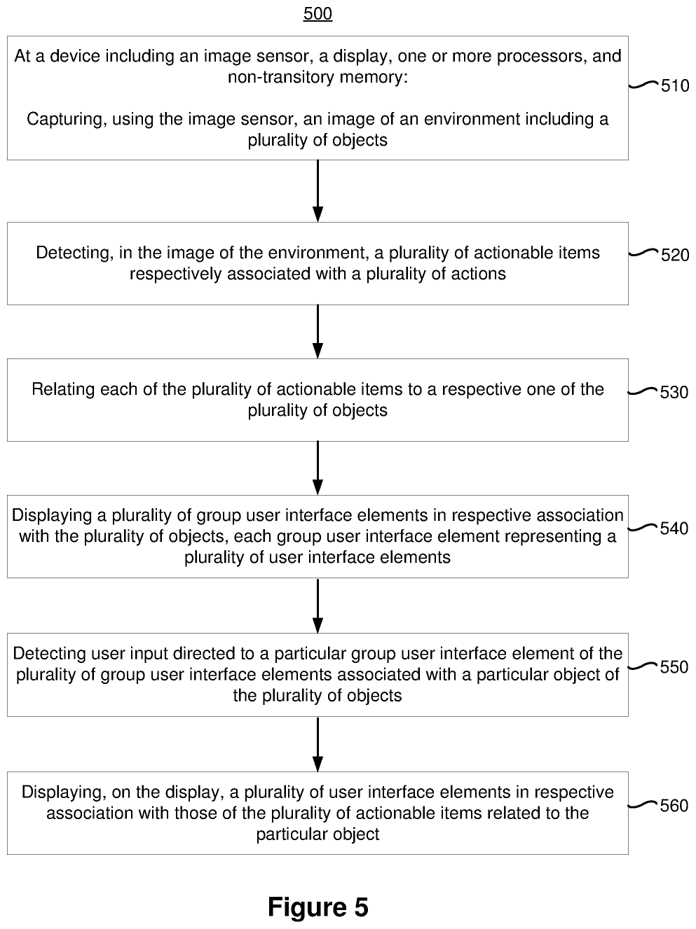

FIG. 5 is a flowchart representation of a method 500 of displaying a plurality of glints in accordance with some implementations. In various implementations, the method 500 is performed by a device including an image sensor, a display, one or more processors, and non-transitory memory (e.g., the electronic device 120 of FIG. 3). In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device capturing, using the image sensor, an image of an environment including a plurality of objects. For example, in FIG. 4A, the electronic device captures an image of the physical environment of the office on which the XR environment 400 is based.

The method 500 continues, in block 520, with the device detecting, in the image of the environment, a plurality of actionable items respectively associated with a plurality of actions. In various implementations, the plurality of actionable items includes machine-readable content. Thus, in various implementations, detecting the plurality of actionable items includes detecting machine-readable content. In various implementations, the machine-readable content includes text, a one-dimensional barcode, or a two-dimensional barcode. For example, in FIG. 4B, the electronic device detects the text of the phone number of the first auto shop in the first window 431 displayed by the laptop 413, the text being associated with an action of calling the phone number of the first auto stop. As another example, in FIG. 4B, the electronic device detects the QR code printed on the takeout menu 416, the QR code being associated with an action of opening a website having a URL encoded by the QR code.

In various implementations, detecting the machine-readable content includes determining an alphanumeric string based on the machine-readable content. In various implementations, the alphanumeric string includes data in a particular recognizable format, such as a phone number, an address, or a URL. In various implementations, the alphanumeric string includes data that matches data in a database, such as words in a dictionary or names in a list of artists.

In various implementations, the plurality of actionable items includes one or more objects. Thus, in various implementations, detecting the plurality of actionable items includes detecting an object of the plurality of objects. For example, in FIG. 4B, the electronic device detects the lamp 412 associated with an action of turning on or off the lamp 412.

The method 500 continues, in block 530, with the device relating (or associating) each of the plurality of actionable items to a respective one of the plurality of objects. For example, in FIG. 4B, the first glint 471A is related to the lamp 412. As another example, in FIG. 4B, the second glint 471B is related to the first window 431 displayed by the laptop 413. As another example, in FIG. 4B, the tenth glint 471J is related to the second page 452 of the book 415. As another example, in FIG. 4B, the fourteenth glint 471N is related to the takeout menu 416.

In various implementations, relating each of the plurality of actionable items to a respective one of the plurality of objects includes performing image segmentation on the image of the environment, such as semantic segmentation or instance segmentation. In performing image segmentation, the device classifies each pixel as belong to a particular class corresponding to an object or to the background. When an actionable item is detected in a region classified as a particular class, it is related to the object corresponding to the particular class.

In relating an actionable item to a respective one of the plurality of objects, the device need not determine an object type of the object to which the actionable item is related. Rather, in various implementations, data regarding the actionable item is stored in association with an object identifier, which may be numeric identifier.

The method 500 continues, in block 540, with the device displaying a plurality of group user interface elements in respective association with the plurality of objects, each group user interface element representing a plurality of user interface elements. For example, in FIG. 4G, the electronic device displays the second group glint 473B in association with the sticky note 414 and displays the third group glint 473C in association with book 415. As another example, in FIG. 4H, the electronic device displays the first sub-group glint 474A in association with the first window 431 and displays the second sub-group glint 474B in association with the second window 432.

The method 500 continues, in block 550, with the device detecting user input directed to a particular group user interface element of the plurality of group user interface elements associated with a particular object of the plurality of objects. For example, in FIG. 4J, the electronic device detects user input directed to the fourth group glint 473D associated with the takeout menu 416. As another example, in FIG. 4H, the electronic device detects user input directed to the second sub-group glint 474B associated with the second window 432.

The method 500 continues, in block 560, with the device displaying, on the display, a plurality of user interface elements in respective association with those of the plurality of actionable items related to the particular object. For example, in FIG. 4K, in response to the user input directed to the fourth group glint 473D, the electronic device displays the twelfth glint 471L, the thirteenth glint 471M, and the fourteenth glint 471N in association with those of the plurality of actionable items related to the takeout menu 416, e.g., the QR code, the address of the restaurant, and the phone number of the restaurant, respectively. As another example, in FIG. 4I, in response to the user input directed to the second sub-group glint 474B, the electronic device displays the fifth glint 471E and the sixth glint 471F in association with those of the plurality of actionable items related to the second window 432, e.g., the name of the first artist and the name of the second artist, respectively.

In various implementations, displaying the plurality of user interface elements in respective association with those of the plurality of actionable items related to the particular object includes displaying the user interface elements proximate to, overlapping, or on top of the actionable items.

In various implementations, the display is an opaque display and the plurality of user interface elements is displayed in respective association with actionable items as a composite image of the plurality of user interface elements and an image of the environment. Thus, in various implementations, displaying the plurality of user interface elements includes displaying, based on an image of the environment, an image representation of the environment including the plurality of user interface elements. In various implementations, the display is a transparent display and the plurality of user interface elements is displayed in association with a physical environment as a projection over a view of the physical environment.

In various implementations, each of the plurality of user interface elements is displayed differently than each of the plurality of group user interface elements. For example, in various implementations, the group user interface elements are bigger and/or brighter than the user interface elements. As another example, in various implementations, the group user interface elements are a different size, shape, or color than the user interface elements.

In various implementations, the method 500 further includes detecting user input directed to a particular user interface element of the plurality of user interface elements associated with a particular actionable item of the plurality of actionable items. For example, in FIG. 4K, the electronic device detects user input directed to the thirteenth glint 471M associated with the address of the restaurant. As another example, in FIG. 4I, the electronic device detects user input directed to the fifth glint 471E associated with the name of the first artist. In various implementations, the method 500 further includes performing an action associated with the particular actionable item. For example, in FIG. 4L, in response to detecting the user input directed to the thirteenth glint 471M, the electronic device performs an action associated with the address of the restaurant, e.g., displaying a map of the address in the virtual map application window 483. As another example, in FIG. 4J, in response to detecting the user input directed to the fifth glint 471E, the electronic device performs an action associated with the name of the first artist, e.g., playing music by the first artist as indicated by the virtual media player window 491.

In various implementations, performing the action associated with the particular actionable item includes displaying content relating to the particular actionable item. For example, in FIG. 4L, in response to the user input directed to the thirteenth glint 471M associated with the address of the restaurant, the electronic device displays not just the virtual map application window 483, but the virtual map application window 483 including a map of the address of the restaurant. As another example, in FIG. 4C, in response to the user input directed to the fourth glint 471D associated with the phone number of the third auto shop, the electronic device displays not just the active call indicator 481, but the active call indicator 481 including the phone number of the third auto shop. As another example, in FIG. 4F, in response to the user input directed to the twelfth glint 471L, the electronic device displays not just the virtual web browser window 482, but the virtual web browser window 482 including the webpage having the URL encoded by the QR code.

In various implementations, performing the action associated with the particular actionable item includes changing a state of the particular actionable item. For example, in response to user input directed to the first glint 471A, in various implementations, the electronic device turns the lamp 412 on or off. As another example, in various implementations, the action includes locking or unlocking a door associated with detecting a door. As another example, in various implementations, the action includes playing or pausing music associated with detecting a speaker.

In various implementations, the method 500 further includes displaying a super-group user interface element in association with an object including two or more of the plurality of objects, the super-group user interface element representing the plurality of group user interface elements. For example, in FIG. 4G, the electronic device displays the first group glint 473A in association with the laptop 413 that includes the first window 431 and the second window 432. As another example, in FIG. 4G, the electronic device displays the third group glint 473C in association with the book 415 that includes the first page 415 and the second page 452.

In various implementations, the method 500 further includes detecting user input directed to the super-group user interface element. For example, in FIG. 4G, the electronic device detects the user input directed to the first group glint 473A. In various implementations, displaying the plurality of group user interface elements (in block 560) is performed in response to detecting the user input directed to the super-group user interface element. For example, in FIG. 4H, the electronic device displays the first sub-group glint 474A and the second sub-group glint 474B in response to detecting the user input directed to the first group glint 473A.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1-13. (canceled)

14. A method comprising:
at a device including an image sensor, a display, one or more processors, and non-transitory memory:
capturing, using the image sensor, an image of an environment including a plurality of objects;
detecting, in the image of the environment, a plurality of actionable items respectively associated with a plurality of actions;
relating each of the plurality of actionable items to a respective one of the plurality of objects;
displaying a plurality of group user interface elements in respective association with the plurality of objects, each group user interface element representing a plurality of user interface elements;
detecting user input directed to a particular group user interface element of the plurality of group user interface elements associated with a particular object of the plurality of objects; and
displaying, on the display, a plurality of user interface elements in respective association with those of the plurality of actionable items related to the particular object.

15. The method of claim 14, wherein detecting the plurality of actionable items includes detecting machine-readable content.

16. The method of claim 14, wherein detecting the plurality of actionable items includes detecting an object of the plurality of objects.

17. The method of claim 14, further comprising:
detecting user input directed to a particular user interface element of the plurality of user interface elements associated with a particular actionable item of the plurality of actionable items; and
performing an action associated with the particular actionable item.

18. The method of claim 17, wherein performing the action associated with the particular actionable item includes displaying content relating to the particular actionable item.

19. The method of claim 17, wherein performing the action associated with the particular actionable item includes changing a state of the particular actionable item.

20. The method of claim 14, wherein relating each of the plurality of actionable items to a respective one of the plurality of object includes performing image segmentation on the image of the environment.

21. The method of claim 14, further comprising:
displaying a super-group user interface element in association with an object including two or more of the plurality of objects, the super-group user interface element representing the plurality of group user interface elements; and
detecting user input directed to the super-group user interface element,
wherein displaying the plurality of group user interface elements is performed in response to detecting the user input directed to the super-group user interface element.

22. The method of claim 14, wherein each of the plurality of user interface elements is displayed differently than each of the plurality of group user interface elements.

23. A device comprising:
an image sensor;
a display;
a non-transitory memory; and
one or more processors to:
capture, using the image sensor, an image of an environment including a plurality of objects;
detect, in the image of the environment, a plurality of actionable items respectively associated with a plurality of actions;
relate each of the plurality of actionable items to a respective one of the plurality of objects;
display a plurality of group user interface elements in respective association with the plurality of objects, each of the plurality of group user interface elements representing a plurality of user interface elements;
detect user input directed to a particular group user interface element of the plurality of group user interface elements associated with a particular object of the plurality of objects; and
display, on the display, a plurality of user interface elements in respective association with those of the plurality of actionable items related to the particular object.

24. The device of claim 23, wherein the one or more processors are to detect the plurality of actionable items by detecting machine-readable content.

25. The device of claim 23, wherein the one or more processors are to detect the plurality of actionable items by detecting an object of the plurality of objects.

26. The device of claim 23, wherein the one or more processors are further to:
detect user input directed to a particular user interface element of the plurality of user interface elements associated with a particular actionable item of the plurality of actionable items; and
perform an action associated with the particular actionable item.

27. The device of claim 26, wherein the one or more processors are to perform the action associated with the particular actionable item by displaying content relating to the particular actionable item.

28. The device of claim 26, wherein the one or more processors are to perform the action associated with the particular actionable item by changing a state of the particular actionable item.

29. The device of claim 23, wherein the one or more processors are to relate each of the plurality of actionable items to a respective one of the plurality of object by performing image segmentation on the image of the environment.

30. The device of claim 23, wherein the one or more processors are further to:
display a super-group user interface element in association with an object including two or more of the plurality of objects, the super-group user interface element representing the plurality of group user interface elements; and
detect user input directed to the super-group user interface element,
wherein the one or more processors are to display the plurality of group user interface elements in response to detecting the user input directed to the super-group user interface element.

31. The device of claim 23, wherein each of the plurality of user interface elements is displayed differently than each of the plurality of group user interface elements.

32. A non-transitory computer-readable medium having instructions encoded thereon which, when executed by a device including a processor, an image sensor, and a display, causes the device to:
capture, using the image sensor, an image of an environment including a plurality of objects;
detect, in the image of the environment, a plurality of actionable items respectively associated with a plurality of actions;
relate each of the plurality of actionable items to a respective one of the plurality of objects;
display a plurality of group user interface elements in respective association with the plurality of objects, each of the plurality of group user interface elements representing a plurality of user interface elements;
detect user input directed to a particular group user interface element of the plurality of group user interface elements associated with a particular object of the plurality of objects; and
display, on the display, a plurality of user interface elements in respective association with those of the plurality of actionable items related to the particular object.

33. The non-transitory computer-readable medium of claim 32, wherein the instructions, when executed, further cause the device to:
detect user input directed to a particular user interface element of the plurality of user interface elements associated with a particular actionable item of the plurality of actionable items; and
perform an action associated with the particular actionable item.
